(19) United States
(12) Patent Application Publication
(10) Pub. No.: US 2012/0207656 A1
(43) Pub. Date: Aug. 16, 2012

(54) System and Method for Recovery of Scandium Values From Scandium-Containing Ores

(75) Inventor: Willem P.C. Duyvesteyn, Reno, NV (US)

(73) Assignee: EMC Metals Corporation

(21) Appl. No.: 13/025,393

(22) Filed: Feb. 11, 2011

(51) Int. Cl. C01F 17/00; B07B 13/00

(52) U.S. Cl. 423/21.1; 423/263; 209/509

(57) ABSTRACT

A method for extracting scandium values from scandium-containing ores is provided. The method comprises (a) providing (203) an ore which contains scandium; (b) treating (205) the ore with an acid; (c) baking the ore; and (d) leaching (207) scandium from the baked ore.

### FIELD OF THE DISCLOSURE

The present disclosure relates generally to systems and methods for producing scandium, and more particularly to systems and methods for recovering scandium values from ore feedstocks.

### BACKGROUND OF THE DISCLOSURE

Scandium is a silvery-white transition metal which was first discovered in the minerals euxenite and gadolinite. While scandium has received considerable academic interest, commercial uses of the metal have been hampered by its low availability, which arises in part from difficulties in its extraction and isolation. Metallic scandium was first produced in 1937 by the electrolysis of a eutectic mixture of potassium, lithium, and scandium chlorides at 700-800° C. The first pound of 99% pure scandium metal was produced in 1960. World production of scandium has been estimated to be on the order of 2-5 tons per year in the form of scandium oxide.

The use of scandium in aluminum alloys first received widespread attention in 1971, following the issuance of a U.S. patent on the technology. The addition of scandium to aluminum limits the excessive grain growth that occurs in the heat-affected zone of welded aluminum components, which has two principle benefits. First of all, the precipitated Al₃Sc intermetallic compound forms smaller crystals than are formed in other aluminum alloys. Secondly, the volume of precipitate-free zones that normally exist at the grain boundaries of age-hardening aluminum alloys is reduced. Both of these effects increase the usefulness of the alloy. Following the discovery of the foregoing benefits, aluminum-scandium alloys found limited application in aerospace industry components, most notably in Russian military aircraft such as the MiG-21 and MiG-29. Typically, these alloys contained between 0.1% and 0.5% of scandium.

Scandia or scandium oxide has also been shown to stabilize zirconium oxide or zirconia, a discovery which has important applications in solid oxide fuel cells. In particular, solid oxide fuel cells commonly utilize yttria-stabilized zirconia as an electrolyte. However, yttria-stabilized zirconia undergoes a catastrophic transformation under hydrothermal conditions at about 300° C. Consequently, as these electrolytes undergo aging under typical fuel cell conditions, precipitates (with a tetragonal crystal geometry) tend to form which reduce the conductivity of the electrolyte. Moreover, cycling of the fuel cell between room temperature and operating temperature in the presence of water (a common product of fuel cell operation) leads to a high likelihood of degradation and failure due to the presence of these precipitates. The addition of 2 mol % yttria to scandia-stabilized zirconia results in the formation of a cubic phase and avoids such phase changes, thus improving the long term stability of the electrolyte. Moreover, scandia-stabilized zirconia offers much higher conductivity than yttria-stabilized zirconia at 1000° C. and provides a larger enhancement at lower temperatures due to the lower activation energy it affords (0.65 eV versus 0.95 eV).

Numerous other uses of scandium have also been identified to date. Indeed, the benefits of scandium are enumerated extensively in the patent literature and are the subject of a comprehensive body of research. However, commercial applications of scandium continue to be limited by the absence of reliable, secure, stable, long-term production of the metal. As a result, scandium remains only sparsely available. Accordingly, even in applications where the use of scandium would be advantageous, industry has been forced to turn to more readily available alternatives. For example, the use of scandium-aluminum alloys in aerospace applications is advantageous because of the lower specific gravity of scandium-aluminum alloys versus the more widely used titanium aluminum alloys (Sc—Al has a specific gravity of 2.8 compared to 4.5 for Ti6Al 4V). In a commercial airline fleet, this difference in specific gravity translates into substantial fuel savings in the course of a year. Moreover, scandium-aluminum alloys are comparable in strength to titanium-aluminum alloys, and are actually less expensive to produce on a cost of raw materials basis. However, despite these advantages, the use of scandium-aluminum alloys in this application has been thwarted by the low availability of scandium.

Despite the low availability of scandium, the metal does not have a particularly low abundance in the earth's crust. Indeed, scandium is a 50^{th} most common element on earth, and is comparable in abundance to cobalt. However, scandium is distributed sparsely, and occurs only in trace amounts in many scandium-bearing ores. Thortveitite and kolbeckite are the primary mineral sources of scandium, and thortveitite, euxenite, and gadolinite are the only known concentrated mineral sources of this element. Thortveitite can contain up to 45% of scandium (in the form of scandium (III) oxide), though the mineral is somewhat rare.

A significant amount of scandium is also extracted from the waste streams or mill tailings of uranium and tungsten plants. Pure scandium is commercially produced by reducing converting scandium oxide to scandium fluoride, and then reducing the scandium fluoride with metallic calcium.

It will be appreciated from the foregoing that a need exists in the art for a system and method for more efficiently extracting scandium from scandium-bearing ores. It will further be appreciated that a need exists in the art for systems and methods of producing scandium alloys, such as aluminum-scandium alloys, in a more cost effective manner. These and other needs may be addressed with the systems and methodologies disclosed herein.

### SUMMARY OF THE DISCLOSURE

In one aspect, a method for extracting scandium values from scandium-containing ores is provided. The method comprises (a) providing an ore which contains scandium; (b) treating the ore with an acid; (c) baking the ore; (d) leaching scandium from the baked ore, (e) and recycling the gaseous effluents to reconstitute the acid used in leaching.

In another aspect, a method is provided for extracting scandium values from scandium-containing ores. The method comprises (a) providing an ore which contains scandium; (b) treating the ore with an acid; (c) baking the ore, thus generating gaseous effluents; (d) recycling the gaseous effluents to reconstitute the acid; and (e) using the reconstituted acid in a second iteration of the method.

In a further aspect, a method for separating ore containing a higher level of scandium content from ore containing a lower level of scandium content is provided. The method comprises (a) providing an ore feedstock in which scandium is preferentially absorbed on feedstock particles having a minimum content of a metal; and (b) separating the feedstock particles having at least the minimum metal content from those feedstock particles which do not have at least the minimum metal content.

In yet another aspect, a method for extracting scandium values from a solution is provided. The method comprises (a) exposing the solution to a substrate containing a metal which preferentially absorbs scandium; and (b) removing the exposed substrate from the solution.

### BRIEF DESCRIPTION OF THE DRAWINGS

FIG. 1 is an illustration of a method for extracting scandium values from ores in accordance with the teachings herein.

FIG. 2 is a phase diagram showing the stability of K-jarosite at 298° K. in the presence of Fe₂O₃ and as a function of Eₕ and pH.

FIG. 3 is a phase diagram showing the stability of K-jarosite at 298° K. in the presence of Fe₂O₃ and Fe(OH)₂⁻and as a function of Eₕ and pH.

FIG. 4 is a phase diagram showing the stability of K-jarosite at 298° K. in the absence of Fe₂O₃ and as a function of Eₕ and pH.

FIG. 5 is a phase diagram showing the stability of K-jarosite at 368° K. in the presence of Fe₂O₃ and as a function of Eₕ and pH.

FIG. 6 is a phase diagram showing the stability of K-jarosite at 368° K. in the presence of Fe₂O₃ and Fe(OH)₂⁻and as a function of Eₕ and pH.

FIG. 7 is a phase diagram showing the stability of K-jarosite at 368° K. in the absence of Fe₂O₃ and as a function of Eₕ and pH.

FIG. 8 is a flowchart for a particular, non-limiting embodiment of a method for obtaining scandium values from a scandium bearing ore.

FIG. 9 is a series of graphs showing the distribution of scandium species as a function of pH at different temperatures.

FIG. 10 is a graph of scandium precipitation as a function of pH.

FIG. 11 is a graph of solubility of ScOOH species as a function of pH at zero ionic strength and at 25° C.

FIG. 12 is a graph showing the predominance of scandium fluoride and scandium hydroxide species as a function of pH and fluoride concentration.

FIG. 13 is a graph of the solubility of ScPO₄ species as a function of pH at a total phosphate concentration of 10⁻⁵ M, zero ionic strength and 25° C.

FIG. 14 is a graph showing the concentration of scandium in Nyngan limonite as a function of iron concentration.

### DETAILED DESCRIPTION

It has now been found that scandium values may be efficiently extracted from scandium-bearing ores using the systems and methodologies disclosed herein. These systems and methodologies may be used to obtain high-purity scandium oxide, which may be further converted to scandium metal.

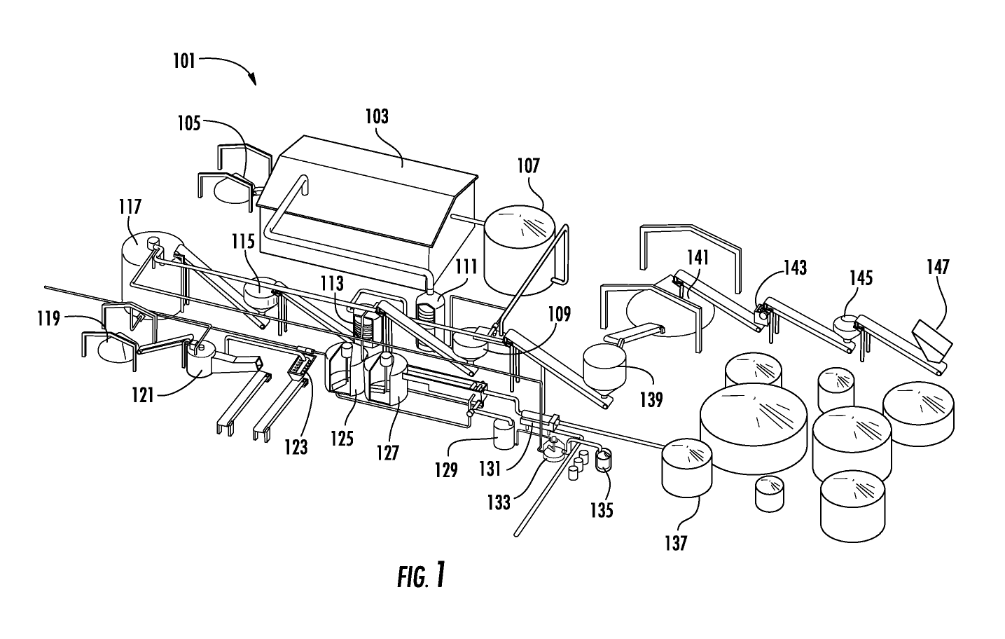

FIG. 1 depicts a first particular, non-limiting embodiment of a system and methodology for extracting scandium values from an ore feedstock. The system 101 depicted therein presumes a feedstock of scandium ore. The feedstock may be obtained directly from a mining operation, and will typically have a particle distribution which is reflective of the type of mining procedure used to recover it.

The feedstock may undergo preliminary processing in order to prepare it for scandium extraction. For example, a particle size reduction step may be included if warranted.

Other preliminary processing steps may also be utilized. For example, a common scandium-bearing ore feedstock may comprise a limonitic material. Limonite is an ore consisting of hydrated iron (III) oxide-hydroxide of varying composition. In particular, limonite is a mixture of similarly hydrated iron oxide minerals, and consists primarily of goethite with lepidocrocite, jarosite, and other such minerals. The scandium may be selectively absorbed on the goethite component, with the result that some of the goethite has scandium absorbed into it, while some does not.

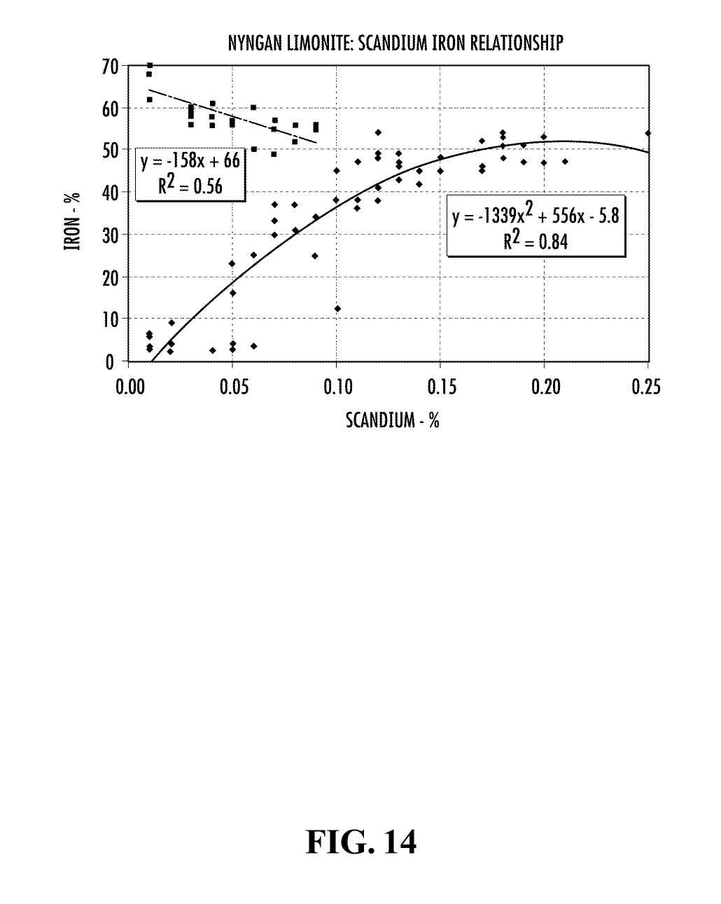

It has been found that goethite having a certain amount of aluminum in its matrix will preferentially absorb scandium. For example, the graph of FIG. 14 shows the concentration of scandium in Nyngan limonite, a known scandium-bearing ore, as a function of Fe concentration. When the Fe content of the ore particles is very high (and hence, the content of Al and Si are low), the scandium content is also low. However, when the ore has a lower Fe content, very high scandium levels are possible. Here, it is to be noted that the nominal scandium content of Nyngan ore (this is for the total ore, not individual ore particles) is only about 0.03% Sc.

This feature may be utilized in various preliminary processing schemes to separate scandium-bearing materials from those which are barren of scandium or contain scandium at lower concentrations, thus significantly improving the efficiency of the scandium extraction process. For example, the difference in aluminum content in the ore gives rise to different physical properties. In particular, the magnetism of goethite is inversely proportional to its aluminum content. This property may be utilized in a magnetic susceptibility process to separate the scandium-bearing goethite from the goethite barren of scandium. While such a step is preferably conducted as a preliminary processing step, it will be appreciated that it may also be implemented later in the process. For example, such a separation may be implemented after the ore is reduced to a certain average particle size.

Various modifications of the foregoing preliminary processing scheme may also be utilized. For example, the fact that goethite which has a minimum amount of aluminum in its matrix will preferentially absorb scandium may be utilized to artificially produce scandium-bearing ores that may be utilized in the systems and methodologies described herein, as by exposing samples of such goethite to waste streams containing scandium under appropriate conditions. These may include, for example, waste streams from uranium processing mills or other ore or metal extraction processes. The scandium-bearing ores so produced may then be utilized as a feedstock in the systems and methodologies disclosed herein.

The ore feedstock may also be subjected to other types of preliminary processing as well. For example, fluoride content may be added to the ore. This may be accomplished, for example, by acid baking and leaching the ore feedstock with suitable fluoride sources. Such fluoride sources may include calcium fluoride, which is readily available as the mineral fluorite, and fluosilicic acid, which is a common waste product in the phosphate industry. Alternatively, mechanical activation by fine grinding of the ore in the presence of these or other suitable fluoride sources may also result in the preferential formation of scandium fluorite. Details of a device suitable for implementing such mechanical activation may be found, for example, in commonly assigned U.S. Ser. No. 12/874,460 (Duyvesteyn), entitled “LOW CARBON DIOXIDE FOOTPRINT PROCESS FOR COAL LIQUEFACTION”, filed on Sep. 2, 2010, which is included herein by reference in its entirety.

As seen in FIG. 1, the first step of the process utilizes a screening system 103 commonly known in the art as a “grizzly”. The screening system 103 operates to separate coarse or oversized material from the ore feedstock, so that the resulting feedstock is characterized by a maximum particle size that can be readily accommodated by the subsequent ore crushing equipment 105.

The screened ore is then passed through a hopper 107 which feeds it into the ore crushing equipment 105. The ore crushing equipment 105, commonly known in the art as a “jaw crusher” or “gyratory crusher”, produces an ore stockpile 109 in which the average particle size in the ore feedstock has been reduced to a level (typically 0.5 inches or less) suitable for subsequent treatment and ore extraction. If necessary, this ore stockpile may be stored in an ore bin 111 until it is subjected to subsequent processing.

The ore stockpile 109 is then treated in a pug mill 113. Within the pug mill 113, the ore is exposed to a suitable acid, which is preferably sulfuric acid. Generally, sulfuric acid is sold as 98% sulfuric acid, since acid concentrations lower than 95% tend to freeze in winter time. However, it has been surprisingly found that the use of slightly less concentrated sulfuric acid is a much more potent leaching and de-structuring agent than 98% sulfuric acid. Preferably, the concentration of the sulfuric acid used for this purpose is within the range of about 85% to about 95%, more preferably within the range of about 87% to about 93%, and even more preferably within the range of about 89% to about 91%. Most preferably, 90% sulfuric acid is used.

Without wishing to be bound by theory, the greater efficacy of slightly diluted sulfuric acid is believed to be due to the fact that the amount of water present in the slightly dilute acid provides a sufficient quantity of H′ ions; however, with so little water, there is not much of an ionic system, and hence the H′ ions are more free for chemical reaction. Thus, the feed acid is preferably diluted either before or after the acid addition to achieve a final concentration in the ranges noted above. While the use of sulfuric acid is preferred, other acids may also be used. These include hydrochloric acid, nitric acid, and mixtures of the foregoing. Without wishing to be bound by theory, it is believed that the acid breaks down the crystal lattice structure of the ore, thereby releasing the scandium content that is locked up in the lattice structure. Alternatively, if scandium is adsorbed on the surface of the ore particles, the break-down of the ore by acid will also facilitate the release of scandium.

The treated ore output by the pug mill 113 is typically in the form of a thick paste. Preferably, the ore is subject to curing for an amount of time after the addition of acid and prior to the subsequent roasting step. This curing time is preferably within the range of about 30 minutes to about 72 hours, more preferably within the range of about 1 to about 48 hours, and most preferably within the range of about 1 to about 24 hours.

Next, the ore is processed in a roaster 115, after which it is held in a calcine tank 123 until needed. The roaster 115 may be a vertical roaster (in which case it is preferably a multiple hearth roaster) or a horizontal roaster (in which case it is preferably a rotary kiln type roaster). If the ore was treated with sulfuric acid in the pug mill 113, then during roasting, SO₂ will be evolved from the processed ore.

The SO₂ evolved from the treated ore is collected by a scrubber 145 and is fed into an acid plant 117, where it is utilized to make reconstituted sulfuric acid. The sulfuric acid produced by the acid plant 117 is stored in a sulfuric acid tank 119, where it is used as needed in the pug mill 113 in the manner described above. The acid plant 117 may draw from a sulfur pile 121 as necessary for the production of make-up sulfuric acid. The provision of an acid plant 117 represents a significant cost savings for the process, because it allows for an almost complete recycle of the sulfates produced by the process. Of course, it will be appreciated that this feature also renders the process more environmentally friendly.

While the foregoing step has been described with reference to sulfuric acid, as noted above, other acids or mixtures of acids may be utilized to treat the ore in the pug mill 113, and the acid reformulation process may be adjusted accordingly. For example, if nitric acid is used to treat the ore in the pug mill 113, then the NOₓ evolved from the treated ore is collected by the scrubber 115 and is fed into the acid plant 117, where it is utilized to make reconstituted nitric acid.

Next, the ore is withdrawn from the calcine tank 123 and is placed in a leaching tank 125, where the scandium values in the ore are extracted. Typically, the acidity (pH) and redox potential (Eₕ) of the leaching solution in the leaching tank 125 will be closely monitored during this process, since these factors will typically determine whether the scandium values will dissolve completely in solution, or whether a portion of the scandium values will re-precipitate. If the solution is maintained in a range conducive to formation of the mineral K-jarosite (potassium iron sulfate hydroxide, or KFe₃(SO₄)₂(OH)₆), then K-jarosite may precipitate out of solution, taking some of the scandium values with it (a similar phenomenon may be observed with the formation of some other jarosites, such as Na-jarosite; hence, these materials will be referred to collectively herein as “jarosite”). Without wishing to be bound by theory, this is believed to be due to the ability of scandium to replace iron in the crystalline lattice structure of jarosite. It is thus preferred that the conditions within the leaching tank 125 are maintained outside of the stability region for jarosite (that is, it is desirable for the pH and/or redox potential to be maintained above or below levels at which jarosite is stable).

The conditions under which jarosite is stable may depend on such factors as acidity (pH), redox potential (Eₕ), temperature, alkali concentration, iron concentration, seeding, the presence of impurities, and other such factors. However, the first three of these enumerated factors are the dominant considerations in many applications.

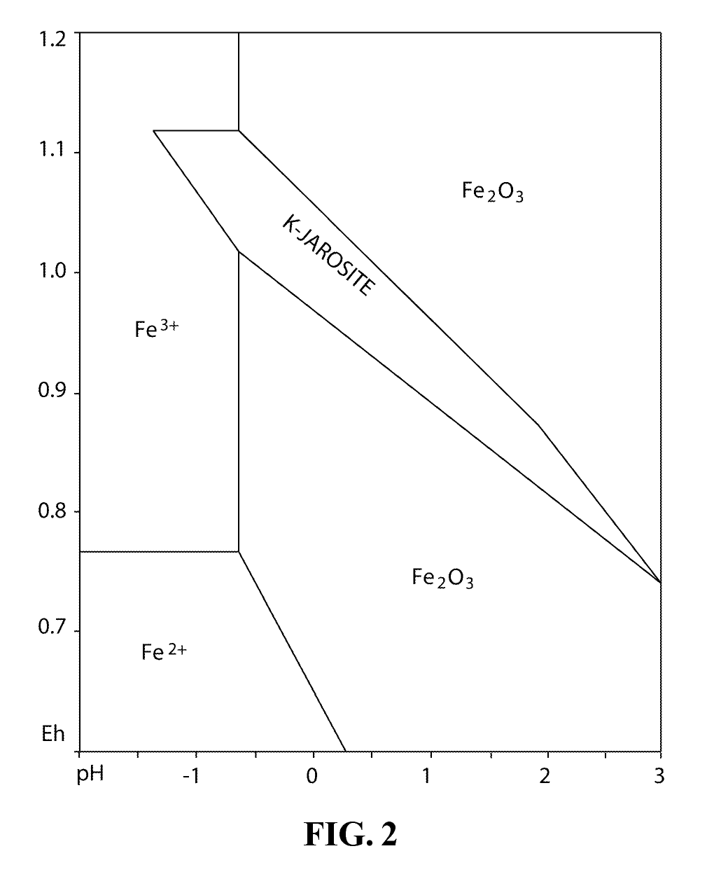

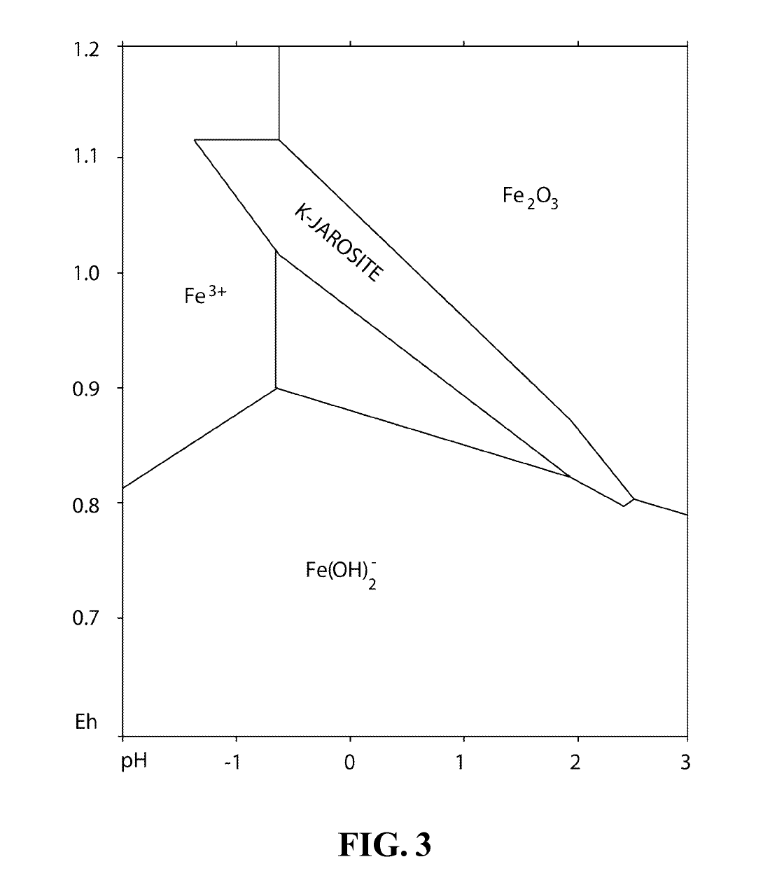

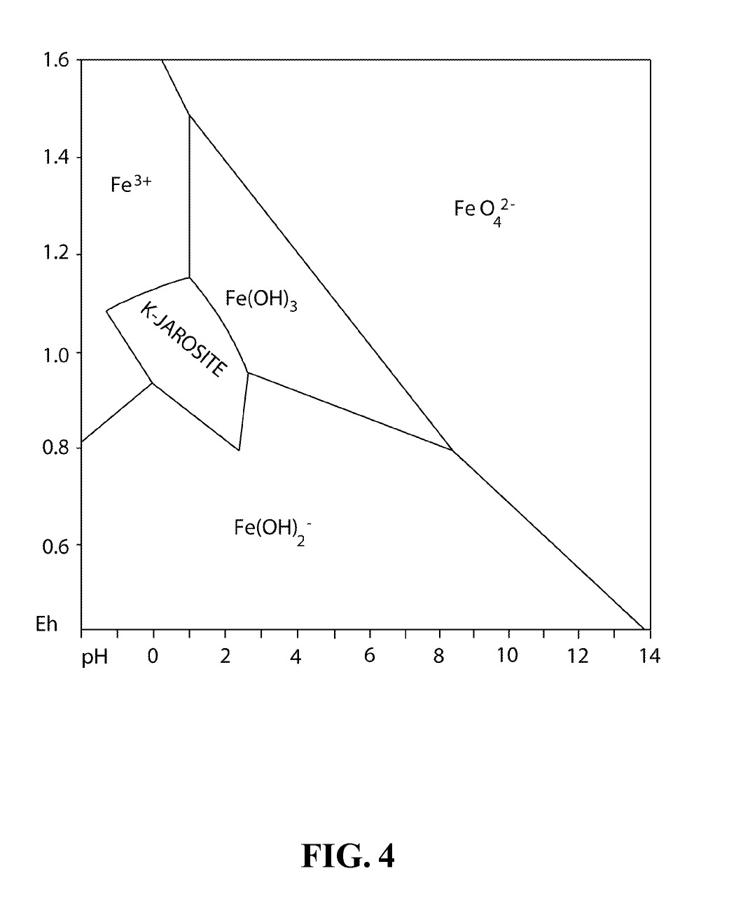

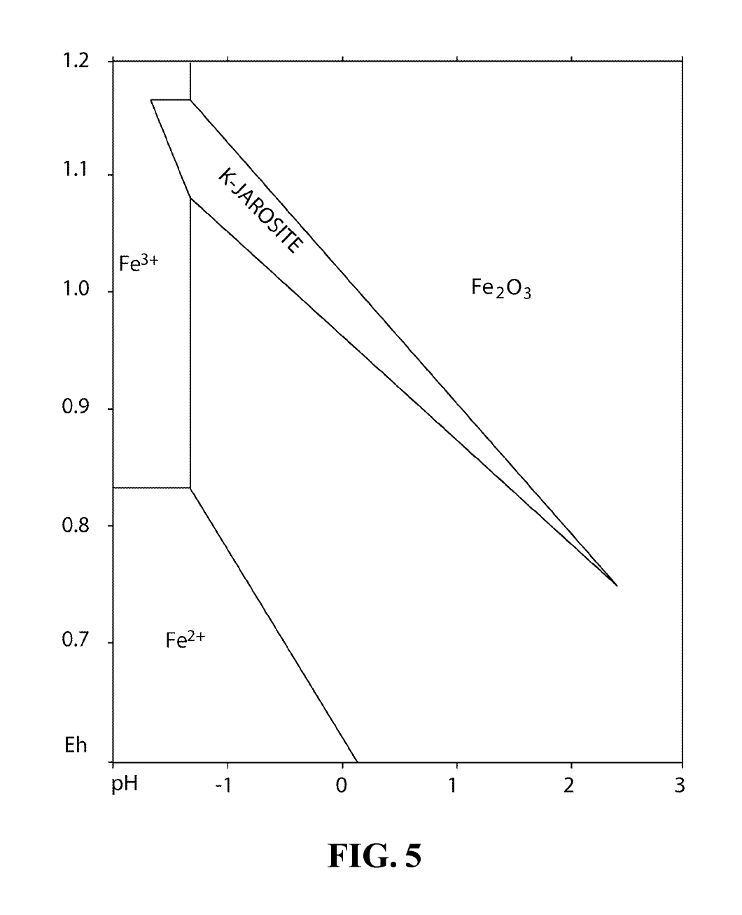

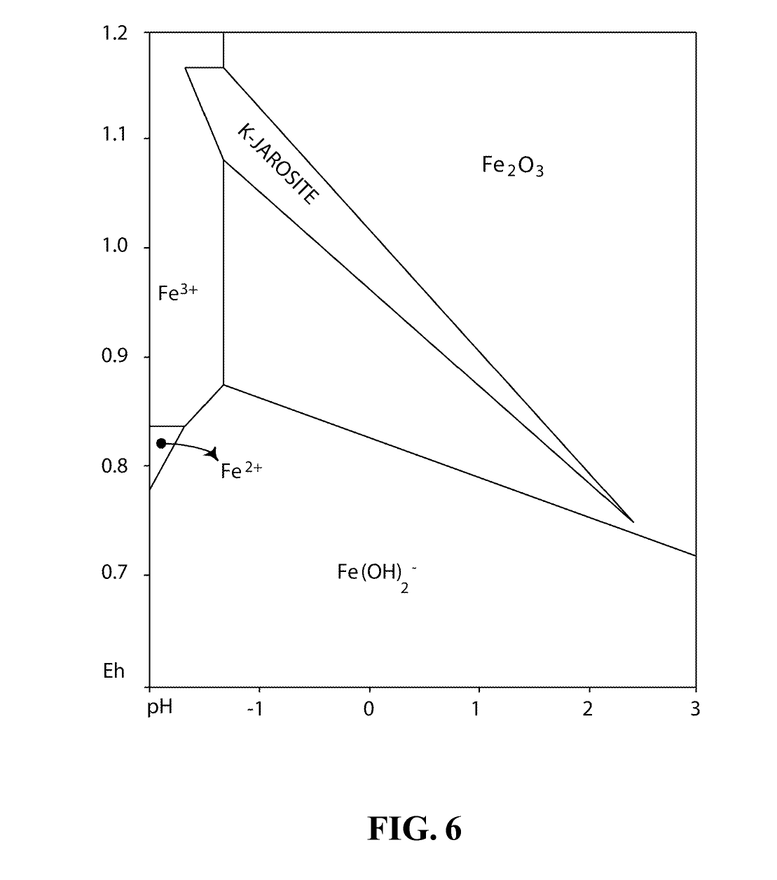

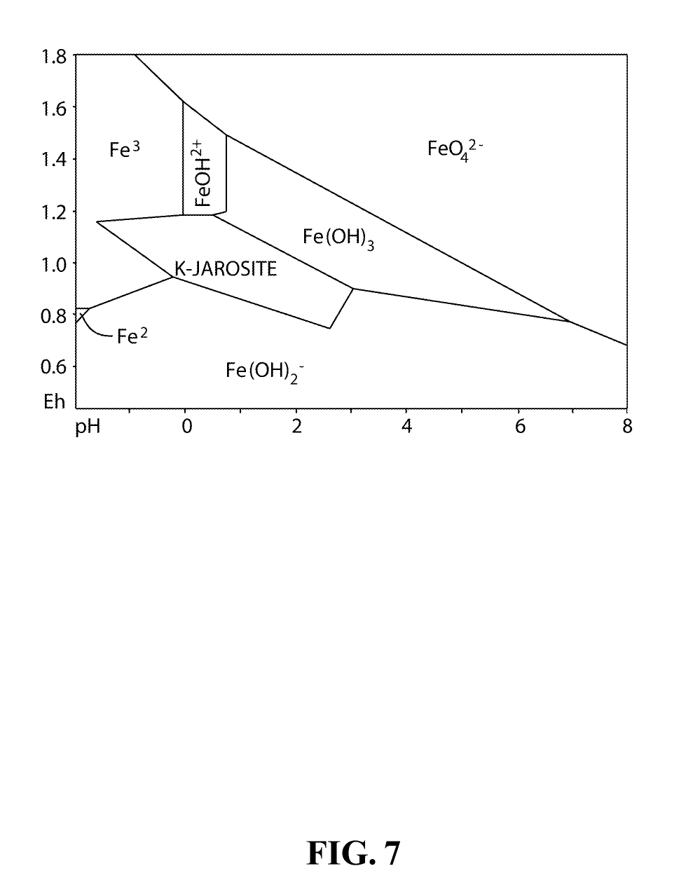

Although the significance of the stability of jarosite to scandium leaching has not heretofore been appreciated in the art, the conditions under which jarosite is stable have been the subject of considerable research due, in part, to the development of jarosite precipitation methods as a means for recovering iron values. For example, C. Arslan and F. Arslan, “Thermochemical Review of Jarosite and Goethite Stability Regions at 25 and 95“C”, Turkish J. Eng. Env. Sci. No. 27, pp. 45-52 (2003), which is incorporated herein by reference in its entirety, provides phase diagrams showing stability regions for K-Jarosite and Goethite under varying conditions of temperature, pH, Eₕ, and the presence (or absence) of materials such as Fe₂O₃ and Fe(OH)₂⁻. One skilled in the art will appreciate that such phase diagrams may be utilized to determine appropriate conditions under which jarosite will be unstable for the purposes of the present methodologies. FIGS. 2-7 depict a series of such phase diagrams for K-jarosite.

While the foregoing conditions may vary from one application to another and may depend, for example, on the ore source the scandium is being extracted from and the particular species of jarosite present, in a typical application, the pH of the leaching solution is preferably greater than about 2.5, more preferably greater than about 3, and most preferably greater than about 3.5, and the redox potential Eₕ will typically be outside of the range of about 0.9 to about 1.0, preferably outside of the range of about 0.8 to about 1.1, more preferably outside of the range of about 0.75 to about 1.15, and most preferably outside of the range of about 0.7 to about 1.2.

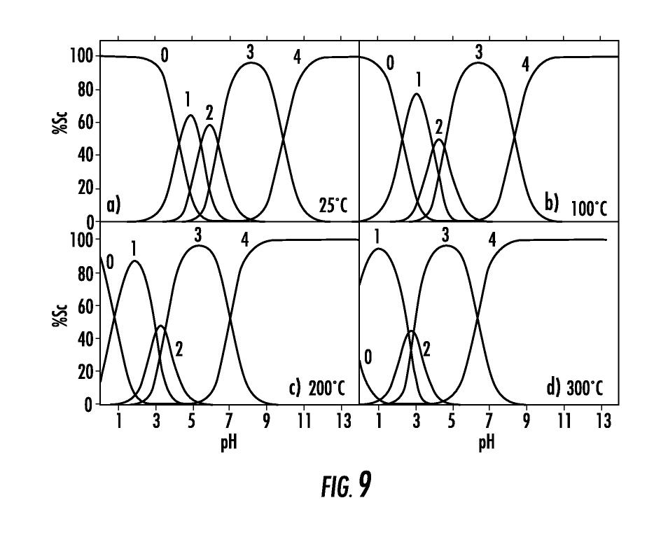

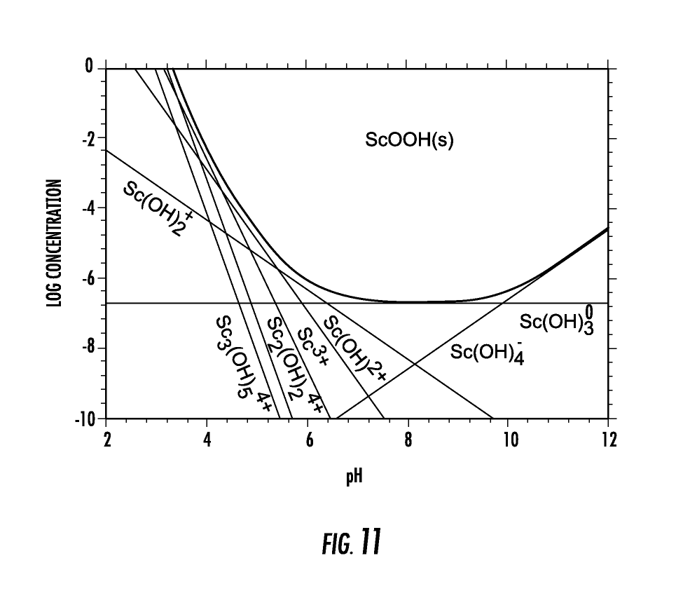

Of course, it is to be noted that scandium chemistry is quite complex, and that different scandium species (and different scandium hydroxide ions, in particular) are formed at different pHs. This point is illustrated in FIG. 9, which shows the distribution of Sc³⁺ hydroxide complexes as a function of pH at 25, 100, 200 and 300° C. The graph in FIG. 11 depicts the solubility of ScOOH species as a function of pH at zero ionic strength and 25° C.; the light lines indicate the concentration of individual Sc(III) species in equilibrium with ScOOH(s), and the heavy curve represents total solubility.

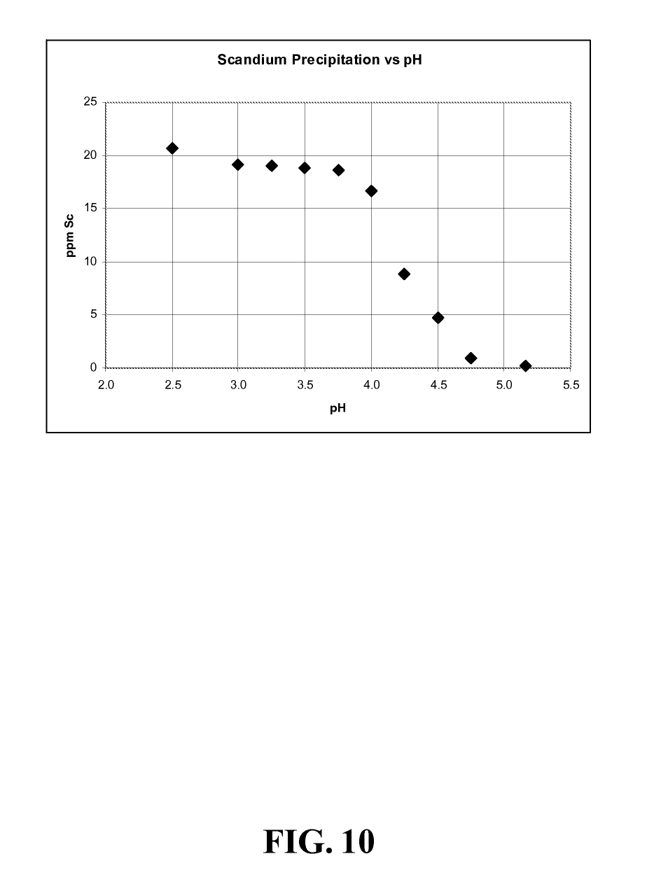

It is also to be noted that scandium precipitation increases with pH and temperature. See S. A. Wood, I. M. Samson, Ore Geology Reviews 28 (2006)57-102. The precipitation of scandium as a function of pH is described in this reference and is shown in FIG. 10.

It has also been found that there is an apparent association in some scandium-bearing ores between scandium and phosphate, with the scandium essentially being present in the ore in some form as an insoluble phosphate. Acid baking appears to solubilize the scandium in the leachate. For example, if the phosphate content is present as calcium phosphate (a common mineral), then treatment of the ore may solubilize the phosphate content as phosphoric acid.

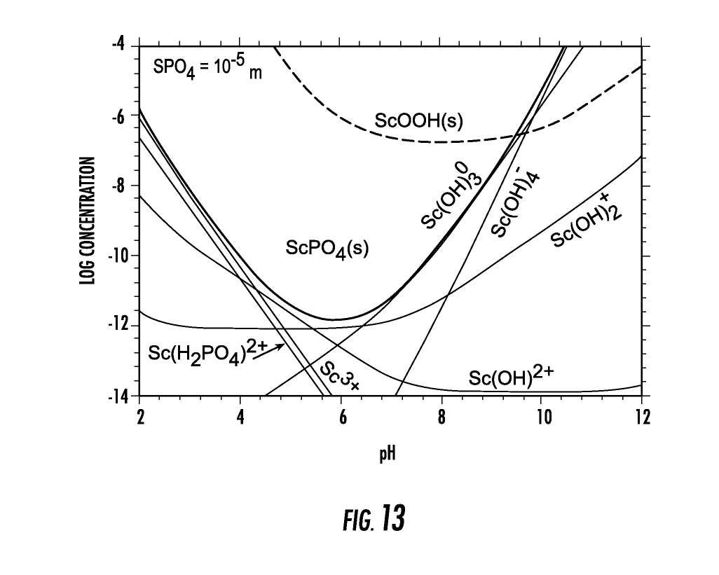

However, it also appears that, if too much phosphate is extracted into the leachate over time, the scandium can re-precipitate. Hence, in some cases, an initial scandium extraction of 90% may be achieved. However, after the sample is washed and re-precipitated, the overall extraction drops to 70% due to scandium losses associated with the formation of insoluble scandium phosphate complexes. The graph in FIG. 13 depicts the solubility of ScPO₄ species as a function of pH and at a total phosphate concentration of 10⁵ M, zero ionic strength and 25° C. The light lines show the concentrations of individual Sc(III) species in equilibrium with ScPO₄ species, and the heavy curve represents the total solubility. The dashed curve shows the solubility of ScOOH(s) for comparison.

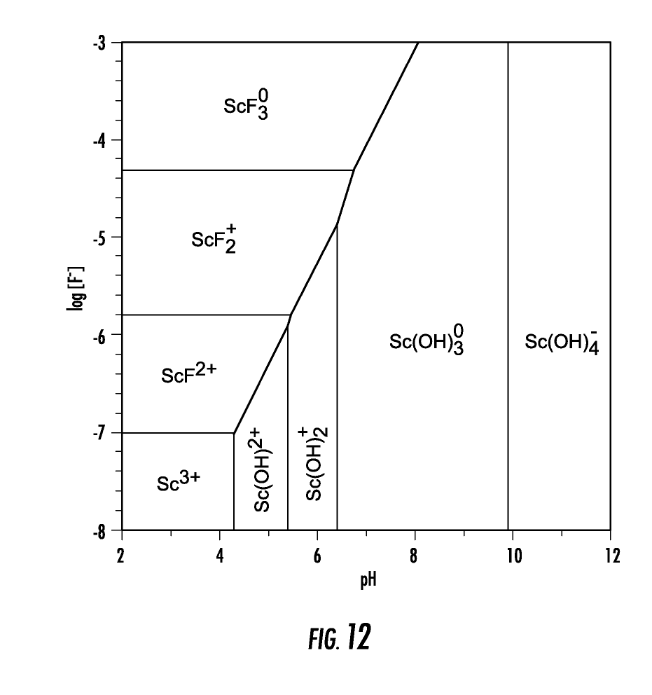

As explained previously, fluoride may be added in various forms to the ore feed. This may occur as a preliminary treatment of the ore, or during one of the later processing steps described herein. The use of a fluoride source may have several advantages. For example, as seen in the graph of FIG. 12, fluoride concentration and pH may be adjusted as desired to achieve the predominance of certain scandium ion species in the leachate, which may prevent the undesirable precipitation of scandium content or, as the case may be, may induce the desirable precipitation of scandium species.

One skilled in the art will appreciate from the foregoing that the optimal operating conditions for the leaching operation may vary from one implementation to another, and may depend on a variety of factors. However, the foregoing graphs, and the relationships they entail, may be utilized to determine optimal operating conditions for a particular implementation of the leaching operation disclosed herein.

After treatment in the leaching tank 125, the resulting mixture is passed through a filter press 127 to separate the solids content of the mixture from the leachate. The scandium contained in the entrained leachate is recovered by washing with a solution that does not result in precipitation of the soluble scandium. Control of both the Eh as well as the pH may be warranted. After the residual scandium is removed, lime is added to the isolated solids, by way of a lime slaker 129 and associated lime pile 131, to reduce the acidity of these materials (e.g., to a pH of about 7) and to produce tailings that are suitable for disposal as dry stackable tailings. The tailings may be processed in a pug mill 132 either during or after this process. If needed, the lime solution can be heated to facilitate impurity precipitation; this will also typically provide enhanced filtration rates.

Meanwhile, the clear filtrate, which at this point comprises chiefly scandium ions in an aqueous medium, is passed to a solvent extraction system 133. In the solvent extraction system 133, scandium is selectively loaded into an organic phase having a high efficiency to selectively extract scandium from a leachate. Such an organic phase preferably comprises an organic solvent dissolved into an organic carrier liquid (or diluent). For example, the organic solvent may comprise thenoyltrifluoroacetone or a mixture of alkyl primary amines, and is present in an amount sufficient to extract the bulk of the scandium content without extracting appreciable amounts of iron and other minerals. The organic carrier may be, for example, an aromatic solvent. Co-loaded impurities such as iron, manganese, and the like are crowded off by the incoming scandium that is contained in fresh leachate.

Once the organic phase is fully loaded with scandium, it is stripped with a mineral acid such as, for example, hydrochloric acid, to yield a pregnant solution that contains the stripped scandium as well as some residual mineral acid. The stripped organic phase is then recycled back to the loading section where leachate solution is contacted with the organic phase.

The volume of the pregnant solution is subsequently reduced, preferably through evaporation of a portion of the solvent, to yield a scandium oxide slurry 135, and the evaporated solvent is recycled to the filter press 127. The scandium oxide slurry 135 is then treated with oxalic acid to precipitate scandium oxalate from it, and the precipitated scandium oxalate is passed through a Neutsche filter 137 to produce a filter cake. The filter cake is then treated in a tray oven 139 to thermally decompose the oxalate and to remove the hydrocarbon content from it, thus yielding scandium oxide 141. The scandium oxide is then re-dissolved in a portion of solvent (this may be recovered solvent from the solvent extraction system 133) and is processed in a centrifuge 143 to remove any precipitates or finely suspended solids, since the presence of these materials may adversely affect the purity of the final product. The final product from the centrifuge 143 is high purity scandium oxide. The mother liquor from the centrifuge 143 may be stored in a tank farm 147 for further treatment.

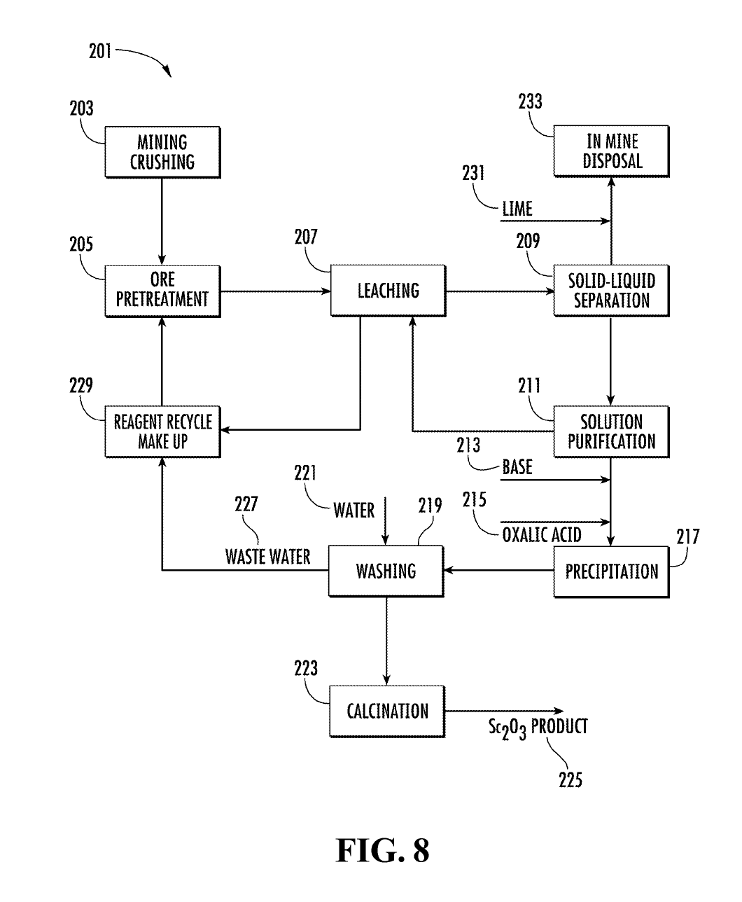

FIG. 8 summarizes some of the general steps in a particular, non-limiting embodiment of a process for recovering scandium values from ore feedstocks in accordance with the teachings herein. As seen therein, the process 201 begins with the mining and crushing 203 of the ore feedstock, followed by suitable pretreatment 205 to prepare the feedstock for subsequent processing. The ore is then subjected to leaching 207 to recover the scandium values from it. The leachate is then separated from the solids through a solid-liquid separation process 209, and the recovered solvent is recycled to the leaching step 207 for further use as explained below. The treated ore feedstock is then treated with lime 211 to neutralize its acid content, and is then disposed 213 in a suitable manner, as through in-mine disposal.

Meanwhile, the leachate is subjected to solution purification 215 and the pH is adjusted appropriately through the addition of base 217. The leachate is then treated with oxalic acid 219 to induce the precipitation 221 of scandium oxalate. The recovered scandium oxalate is washed 223 (with water 225) and subjected to calcinations 227 to yield the final Sc₂O₃ product. The waste water 227 from the washing step 223 and the solvent recovered from the solid-liquid separation process 209 are then utilized in a reagent recycle and make up process 229, and the recycled reagents are used in further iterations of the ore pretreatment process 205.

Various modifications to the foregoing process are possible. For example, an ion exchange step may be utilized in addition to, or in lieu of, the solvent extraction system 133. In some implementations of the process, the use of oxalic acid to precipitate scandium oxalate may result in the precipitation of other undesirable materials. In such implementations, the use of an ion exchange resin to purify the solution prior to precipitation may improve the purity of the final product.

In some implementations of the systems and methodologies described herein, fractional sublimation or distillation may be utilized as part of the process to separate scandium from other metals and materials or to purify scandium. By way of example, the scandium metal or scandium oxide present in the leachate or the subsequent solutions obtained in the process of FIG. 8 may be converted to scandium chloride. Scandium chloride (ScCl₃) has a boiling temperature of 967° C., and hence is readily separated from the chlorides of other metals and materials occurring in scandium bearing ores such as yttrium chloride (YCl₃; b.p.=1507° C.), zirconium chloride (ZrCl₄; b.p.=331° C.), iron chloride (FeCl3; sublimes at 310° C.), aluminum chloride (AlCl₃; b.p.=180° C.), titanium chloride (TiCl₄; b.p.=136° C.), and silicon chloride (SiCl₄; b.p.=57° C.). Of course, it will be appreciated that similar methods of separation or purification which are based on the conversion of scandium into other compounds (including various salts, such as the fluorides or other halides, and various oxides) may also be utilized.

In some embodiments, various preliminary processes may be employed to concentrate scandium in the feedstock before it is subjected to processing in accordance with the teachings herein. For example, chlorination of the ore feedstock can have the effect of preferentially volatilizing the chlorides of other metals from the feedstock, thus concentrating scandium in the remaining ore solids. The volatilized materials may then be harvested as additional products of the ore recovery process.

In some implementations of the systems and methodologies described herein, solvent extraction may also be utilized to separate scandium from other metals. For example, scandium may be separated from iron and manganese in the leachate by extracting essentially all of the scandium from the solution with a solvent system consisting essentially of an extracting agent (such as, for example, a dialkyl phosphoric acid) in a solvent (such as an aromatic solvent). The extracting agent is preferably present in an amount sufficient to extract essentially all of the scandium without extracting appreciable amounts of iron and manganese. The scandium containing organic solution may then be stripped of its scandium content with, for example, an aqueous ammonium carbonate solution which is separated from the stripped organic.

If desired, the scandium oxide obtained from the processes described herein may be converted into scandium metal. This may be achieved, for example, by treating the scandium oxide in a calcium reduction cell to produce scandium metal and calcium oxide. The scandium so obtained may then be alloyed with aluminum to obtain aluminum-scandium alloys of various compositions.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A method for extracting scandium values from scandium-containing ores, the method comprising:
providing an ore which contains scandium;
treating the ore with an acid;
baking the ore; and
leaching scandium from the baked ore under conditions which are not conducive to the formation of a scandium-containing precipitate.

2. The method of claim 1, wherein scandium is leached from the baked ore under conditions which are not conducive to the formation of K-jarosite.

3. The method of claim 1, wherein scandium is leached from the baked ore under conditions in which K-jarosite is unstable.

4. The method of claim 3, wherein the pH of the leaching solution is maintained at a value greater than 2.5 during leaching.

5. The method of claim 3, wherein the pH of the leaching solution is maintained at a value greater than 3.0 during leaching.

6. The method of claim 3, wherein the pH of the leaching solution is maintained at a value greater than 3.5 during leaching.

7. The method of claim 3, wherein the redox potential of the leaching solution is maintained outside of the range of about 0.9 to about 1.0 during leaching.

8. The method of claim 3, wherein the redox potential of the leaching solution is maintained outside of the range of about 0.8 to about 1.1 during leaching.

9. The method of claim 3, wherein the redox potential of the leaching solution is maintained outside of the range of about 0.75 to about 1.15 during leaching.

10. The method of claim 3, wherein the redox potential of the leaching solution is maintained outside of the range of about 0.7 to about 1.2 during leaching.

11. The method of claim 3, wherein the pH of the leaching solution is maintained above about 2.5 during leaching, and wherein the redox potential of the leaching solution is maintained outside of the range of about 0.9 to about 1.0 during leaching.

12. The method of claim 3, wherein the pH of the leaching solution is maintained above about 3.0 during leaching, and wherein the redox potential of the leaching solution is maintained outside of the range of about 0.8 to about 1.1 during leaching.

13. The method of claim 3, wherein the pH of the leaching solution is maintained above about 2.5 during leaching, and wherein the redox potential of the leaching solution is maintained outside of the range of about 0.7 to about 1.2 during leaching.

14. The method of claim 1, wherein the acid is sulfuric acid.

15. The method of claim 1, wherein the acid is nitric acid.

16. The method of claim 14, wherein treating the ore with an acid releases scandium from the crystal lattice structure of the ore.

17. The method of claim 13, wherein baking the ore thermally decomposes the acid.

18. The method of claim 13, wherein the acid is sulfuric acid, and wherein baking the ore releases SO₂ from the ore.

19. The method of claim 18, further comprising:
collecting the SO₂ generated by the baking step in a first iteration of the method; and using the SO₂ to make sulfuric acid which is used in treating the ore with an acid in a second iteration of the method.

20. The method of claim 19, wherein the SO₂ is collected with a scrubber.

21. The method of claim 13, wherein the acid is nitric acid, and wherein baking the ore releases NOₓ from the ore.

22. The method of claim 21, further comprising:
collecting the NOₓ generated by the baking step in a first iteration of the method; and
using the NOₓ to make nitric acid which is used in treating the ore with an acid in a second iteration of the method.

23. The method of claim 22, wherein the NOₓ is collected with a scrubber.

24. The method of claim 1, wherein leaching scandium from the baked ore results in a solution of scandium oxide.

25. A method for extracting scandium values from scandium-containing ores, the method comprising:
providing an ore which contains scandium;
treating the ore with an acid;
baking the ore, thus generating gaseous effluents;
recycling the gaseous effluents to reconstitute the acid; and
using the reconstituted acid in a second iteration of the method.

26. (canceled)

27. (canceled)
